(19) United States
(12) Patent Application Publication
(10) Pub. No.: US 2007/0287758 A1
(43) Pub. Date: Dec. 13, 2007

(54) Suspensions Comprising Calcium Carbonate Particles Exhibiting a Controlled State of Aggregation

(75) Inventors: Myriam Ricaud, Montpellier (FR); Karine Cavalier, Arles (FR); Roberto Rosa, Ranco (IT); Francis Larche, Les Matelles (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SOLVAY (SOCIETE ANONYME), Brussels (BE)

(21) Appl. No.: 11/666,090

(22) PCT Filed: Oct. 24, 2005
(86) PCT No.: PCT/EP05/55487

§ 371 Date: Apr. 24, 2007

(30) Foreign Application Priority Data
Oct. 25, 2004 (FR) 04/11378

(51) Int. Cl. C01F 11/18

(52) U.S. Cl. 516/88

(57) ABSTRACT

Aqueous suspension of particles of precipitated calcium carbonate meeting the following requirements: d_{P}≦D₅₀≦q.d_{P} where d_{P} is the mean diameter of the particles (nm), measured by the Lea-Nurse method, D₅₀ is the diameter of the particles (nm) for which 50% of the distribution (measured by the sedimentation technique) is smaller and 50% of the distribution is greater, q is a number between 1.0 and 20.0, and comprising an additive chosen from nonionic compounds comprising more than one carbon atom, the content of which, with respect to the calcium carbonate, is greater than 0.4% by weight.

The invention relates to aqueous suspensions comprising calcium carbonate particles.

It relates more particularly to suspensions where the calcium carbonate particles exhibit a controlled state of aggregation, to a process for the preparation of such suspensions and to the use of these suspensions in various applications.

Various processes are available for producing aqueous calcium carbonate suspensions.

These suspensions can, for example, be obtained by dry milling natural calcium carbonate, the latter subsequently being suspended in water. The milling can also be carried out directly in water. However, in these processes, the size distributions of the aggregates of particles, such as obtained by sedimentation methods, for example, are broad. In order to obtain narrow distributions, it may be necessary to resort to sieving stages. The latter result in additional costs in time and in energy. Furthermore, these sieving operations can result in undesirable discharges of particle size fractions and thus in a loss of starting material.

Aqueous calcium carbonate suspensions can also be obtained by precipitation processes starting from solutions or suspensions comprising a calcium compound. Generally, the size distribution of the aggregates which is obtained by these processes is fairly broad.

In these processes, the composition of the aggregates, namely the number of individual particles constituting them, is not controlled.

Calcium carbonate suspensions are generally used in various applications relating to the fields of paints, coatings, plastics, paper, pharmaceuticals, cosmetics and food, in particular. The presence in these suspensions of calcium carbonate aggregates with variable sizes can result in poor dispersion of the calcium carbonate with the consequence of a deterioration in the properties of the resulting compositions.

The carbonation of milk of lime in the presence of methanol is carried out in the document EP 0 459 339 A1. This process makes it possible to obtain a suspension of calcium carbonate virtually devoid of aggregates. It does not make it possible to obtain aggregates of controlled size and composition. In point of fact, the optimum size and the optimum composition of the aggregates vary according to the type of application envisaged.

The current problem is thus that of making available calcium carbonate suspensions where the size of the aggregates can be controlled from the size of the individual particles up to sizes several times greater.

The invention is thus targeted at providing suspensions of precipitated calcium carbonate particles where the calcium carbonate particles exhibit a controlled state of aggregation.

The invention is also targeted at providing a process for the preparation of suspensions of precipitated calcium carbonate particles where the calcium carbonate particles exhibit a controlled state of aggregation.

The invention is also targeted at applications of the suspensions of precipitated calcium carbonate particles where the calcium carbonate particles exhibit a controlled state of aggregation.

Finally, the invention is targeted at the use of additives chosen from nonionic compounds comprising more than one carbon atom for controlling the state of aggregation in the manufacture of suspensions of particles of precipitated calcium carbonate.

It has now been found that, by adding a given amount of a nonionic compound comprising more than one carbon atom to the medium for precipitation of the calcium carbonate, it is possible to control the size of the aggregates of particles in the calcium carbonate suspensions.

Consequently, the invention relates to aqueous suspensions of particles of precipitated calcium carbonate meeting the following requirements:
d_{P}≦D₅₀≦q.d_{P}
where
d_{P} is the mean diameter of the particles (nm), measured by the Léa-Nurse method,
D₅₀ is the diameter of the particles (nm) for which 50% of the distribution (measured by the sedimentation technique) is smaller and 50% of the distribution is greater,
q is a number between 1.0 and 20.0,
and comprising at least one additive chosen from nonionic compounds comprising more than one carbon atom, the content of which, with respect to the calcium carbonate, is greater than 0.4% by weight.

The precipitated calcium carbonate involved in the suspension according to the invention can be obtained by precipitation of calcium carbonate starting from milk of lime with carbon dioxide (carbonation process) or with an alkaline carbonate (causticizing process) or starting from solutions comprising calcium chloride by addition of an alkaline carbonate.

The suspension of precipitated calcium carbonate generally exhibits a pH of less than or equal to 9, preferably of less than or equal to 8 and more particularly of less than or equal to 7.5. The suspension of precipitated calcium carbonate exhibits a pH usually of greater than or equal to 5, more specifically of greater than or equal to 6. A pH of greater than or equal to 7 is very particularly preferred.

The suspension of precipitated calcium carbonate generally exhibits a sodium content of less than or equal to 1000 ppm by weight, preferably of less than or equal to 100 ppm by weight and more particularly of less than or equal to 50 ppm by weight. The suspension of precipitated calcium carbonate exhibits a sodium content usually of greater than or equal to 10 ppm by weight, more specifically of greater than or equal to 20 ppm by weight. A sodium content of greater than or equal to 30 ppm by weight is very particularly preferred.

According to a means preferred in the context of the invention, the precipitated calcium carbonate is calcium carbonate precipitated by carbonation of a milk of lime.

The calcium carbonate can be substantially amorphous or substantially crystalline. The term “substantially amorphous” or “substantially crystalline” is understood to mean that more than 50% by weight of the calcium carbonate is in the form of amorphous or crystalline material when analysed by the X-ray diffraction technique. Substantially crystalline calcium carbonates are preferred. The calcium carbonate can be composed of calcite, of vaterite or of aragonite or of a mixture of at least two of these crystallographic varieties. The calcite variety is preferred.

The mean diameter of the individual particles of calcium carbonate can vary to a large extent. The individual particles are defined as the smallest discrete crystallites that can be observed by electron microscopy. This diameter is, however, generally less than or equal to 1 μm. Particles with a diameter of less than or equal to 200 nm are especially advantageous, diameters of less than or equal to 90 nm being preferred. Particles with a diameter of greater than or equal to 15 nm are highly suitable. Particles with a diameter of greater than or equal to 30 nm are particularly well suited. The mean diameter of the individual particles is measured by the Léa-Nurse method (Standards NFX 11-601, 1974). The d_{P} value is obtained from the massic area (S_{M}) derived from the Léa and Nurse method by making the assumptions that all the particles are spherical, non porous and of equal diameter, and by neglecting contact surfaces between the particles.

The relationship between d_{P} and S_{M} is the following:
d_{P}=6/(ρS_{M})
where
ρ is the specific mass of the calcium carbonate.

The mean diameter of the aggregates of individual particles of calcium carbonate can vary to a large extent. However, this diameter is generally less than or equal to 20 μm, preferably less than or equal to 4 μm. Aggregates with a diameter of less than or equal to 600 nm are especially advantageous, diameters of less than or equal to 100 nm being preferred. Aggregates with a diameter of greater than or equal to 15 nm are highly suitable. Aggregates with a diameter of greater than or equal to 60 nm are particularly well suited. The mean diameter of the aggregates is obtained on the basis of the size distribution of the particles determined by the sedimentation method using a Micromeritics SediGraph 5 100 measuring device for sizes ranging from 0.1 to 300 μm (standard ISO 13317-3) and using a Horiba CAPA 700 measuring device for sizes ranging from 0.01 to 300 μm (standard ISO 13318-2). It is the diameter of the aggregates of the individual particles for which 50% of the distribution (by weight, measured by the sedimentation technique) is smaller and 50% of the distribution is greater (D₅₀). Without wishing to be committed to any one theory, it is believed that the size of the aggregates defines the sedimentation phenomenon which is at the basis of the measurement method.

The width of the size distribution curve as obtained by one of the preceding methods can be varied to a large extent. This width is defined by the following SPAN number:
SPAN=(D₉₀−D₁₀)/D₅₀
where
D₉₀ is the diameter of the aggregates for which 90% of the distribution (by weight, measured by the sedimentation technique) is smaller and 10% of the distribution is greater,
D₅₀ is the diameter of the aggregates for which 50% of the distribution (by weight, measured by the sedimentation technique) is smaller and 50% of the distribution is greater, and
D₁₀ is the diameter of the aggregates for which 10% of the distribution (by weight, measured by the sedimentation technique) is smaller and 90% of the distribution is greater.

This number is generally higher than or equal to 0.01, often higher than or equal to 0.1 and frequently higher than or equal to 0.5. This number is usually lower than or equal to 1.4, preferably lower than or equal to 1.2 and particularly preferably lower than or equal to 0.75.

In the suspensions according to the invention, the mean diameter of the aggregates (D₅₀) is generally between the mean diameter of the individual particles (d_{P}) and a multiple q of this diameter (q.d_{P}). This multiple is a number generally of less than or equal to 20.0, particularly of less than or equal to 17.0, more particularly of less than or equal to 14.0 and very particularly of less than or equal to 11.0. This multiple is a number usually of greater than or equal to 1.0, preferably greater than 1.0, particularly preferably of greater than or equal to 3.0, very particularly preferably of greater than or equal to 5.0. Values of q of greater than or equal to 8.0 give particularly good results.

The term “control of the state of aggregation of the particles of precipitated calcium carbonate” is understood to mean the control of the size of the aggregates of the said particles, characterized by the mean diameter D₅₀ defined above, of the size distribution of the aggregates, as characterized by the SPAN number defined above, and of the composition of the aggregates, characterized by the number of individual particles constituting them and characterized by the number q defined above.

The calcium carbonate involved in the suspensions according to the invention generally exhibits a specific surface of greater than or equal to 5 m²/g, advantageously greater than or equal to 10 m²/g. The specific surface is more advantageously greater than or equal to 20 m²/g. A specific surface of greater than or equal to 50 m²/g is particularly recommended. The specific surface is generally less than or equal to 100 m²/g, preferably less than or equal to 90 m²/g, the values of the specific surface of less than or equal to 70 m²/g being very particularly preferred. The specific surface is measured by the standardized BET method (Standard ISO 9277, first edition, 1995-05-15).

The calcium carbonate involved in the suspensions according to the invention can exhibit various morphologies. The individual particles can have the form of needles, scalenohedra, rhombohedra, spheres, platelets or prisms. The rhombohedral form, which can be reduced to pseudocubes or to pseudospheres, is preferred.

The concentration of calcium carbonate in the suspension is generally greater than or equal to 20 g/l, preferably greater than or equal to 50 g/l and very especially greater than or equal to 150 g/l. This concentration is usually less than or equal to 500 g/l and more specifically less than or equal to 250 g/l. Concentrations of less than or equal to 220 g/l are particularly well suited.

The term “nonionic compound” is understood to mean compounds which do not carry electric charges when brought into the presence of water, as in aqueous calcium carbonate suspensions, for example. The nonionic compound can be monomeric or polymeric. Polymeric compounds are preferred. The polymeric compounds can be of natural or synthetic origin. Polymeric compounds of synthetic origin are preferred. The expression “polymeric compound” is used as generally accepted and invariably denotes a homopolymer, a copolymer or a blend of homopolymers and/or of copolymers.

In a first embodiment according to the invention, the polymer is a condensate of alkylene oxide with an alcohol. Preferably, the polymer is a condensate of ethylene oxide with an alcohol (ethoxylated alcohol).

The term “ethoxylated alcohol” is understood to denote the compounds which correspond to the following general formula
R—(OCH₂CH₂)ₚOH.

In these compounds, p can be a number greater than or equal to 1, preferably greater than or equal to 5 and very particularly greater than or equal to 8. This number is generally less than or equal to 50, more particularly less than or equal to 20. Values of this number of less than or equal to 10 are particularly well suited. In these compounds, R can denote an alkyl, aryl, alkylaryl or aralkyl group comprising a number of carbon atoms of greater than or equal to 1, preferably of greater than or equal to 5 and more specifically of greater than or equal to 10. This number is generally less than or equal to 30, more specifically less than or equal to 20. Values of less than or equal to 15 are particularly well suited. The compound corresponding to the formula
C₈H₁₇-Φ-(OCH₂CH₂)_{9.5}OH
where Φ represents a phenyl radical, is particularly preferred. This compound is sold under the name of Triton® X 100.

In a second embodiment according to the invention, the polymer is a polyalkylene glycol. Preferably, the polymer is a copolymer based on alkylene oxides. Copolymers based on ethylene oxide and on propylene oxide are particularly preferred. Block copolymers are very particularly preferred. Triblock copolymers are particularly well suited. The term “triblock copolymers based on ethylene oxide and on propylene oxide” is understood to denote the compounds of formula
HO[(CH₂CH₂O)](CH₂CH(CH₃)O)ₘ(CH₂CH₂O)ₙ]H.

In this formula, 1 and n can be identical or nonidentical numbers greater than or equal to 1, more specifically greater than or equal to 10 and very especially greater than or equal to 20. These numbers can generally be less than or equal to 200, more specifically less than or equal to 175. Numbers of less than or equal to 150 are highly suitable.

In this formula, m is a number generally of greater than or equal to 1, more specifically of greater than or equal to 10 and very especially of greater than or equal to 15. This number is generally less than or equal to 150, more specifically less than or equal to 100. A number of less than or equal to 60 is highly suitable.

The block copolymers where l=n=42 and m=16, l=n=77 and m=30, l=n=25 and m=56, l=n=37 and m=56 and l=n=148 and m=56 are particularly well suited. They are sold under the respective names of Synperonic® F 38, F 68, P 104, P 105 and F 108. The copolymer corresponding to the formula
HO[(CH₂CH₂O)₁₄₈(CH₂CH(CH₃)O)₅₆(CH₂CH₂O)₁₄₈]H (Synperonic® F 108)
is very particularly preferred.

The block copolymers of ethylene oxide and of propylene oxide usually have an average molar mass of greater than or equal to 1000 g/mol, preferably of greater than or equal to 2000 g/mol, particularly preferably of greater than or equal to 3000 g/mol and very particularly preferably of greater than or equal to 3500 g/mol. This average molar mass is usually less than 200 000 g/mol, more specifically less than or equal to 100 000 g/mol. Values of less than 20 000 g/mol are particularly well suited. A block copolymer of ethylene oxide and of propylene oxide with an average molar mass of 16 200 g/mol gives particularly good results.

The block copolymers of ethylene oxide and of propylene oxide generally have an ethylene oxide content of greater than or equal to 10 mol %, preferably of greater than or equal to 45 mol % and very particularly preferably of greater than or equal to 80 mol %. This content is usually less than 99 mol %, more specifically less than or equal to 95 mol %. Values of less than 90 mol % are particularly well suited. A block copolymer of ethylene oxide and of propylene oxide with an ethylene oxide content of 84 mol % gives particularly good results.

The content of additive in the suspension is generally greater than or equal to 0.5 g/l, preferably greater than or equal to 1.0 g/l and very particularly preferably greater than or equal to 2.5 g/l. This content is usually less than or equal to 6.0 g/l, more specifically less than 4.5 g/l. A content of less than or equal to 4.0 g/l is particularly well suited.

The amount of additive, with respect to the amount of dry calcium carbonate, is generally greater than 0.4% by weight, preferably greater than or equal to 0.75% by weight and very particularly preferably greater than 1% by weight. This content is usually less than or equal to 4% by weight, more specifically less than 3.5% by weight. A content of less than or equal to 3% by weight is particularly well suited.

The additive can be partially adsorbed at the surface of calcium carbonate particles.

The invention is also about a process for the manufacture of a suspension particles of precipitated calcium carbonate, meeting the following requirements:
d_{P}≦D₅₀≦q.d_{P}
where
d_{P} is the mean diameter of the particles (nm), measured by the Léa-Nurse method,
D₅₀ is the diameter of the particles (nm) for which 50% of the distribution (measured by the sedimentation technique) is smaller and 50% of the distribution is greater,
q is a number between 1.0 and 20.0,
and where the precipitated calcium carbonate is obtained by carbonation of milk of lime by a gas comprising carbon dioxide, in the presence of at least one additive chosen from nonionic compounds comprising more than one carbon atom, the content of which, with respect to the calcium carbonate, is greater than 0.4% by weight.

According to the process for the manufacture of the suspensions according to the invention, the additive defined above is added to the medium for precipitation of the calcium carbonate. The additive can be added at any point in the precipitation reaction, that is to say before or during the precipitation. The additive is added before the end of the precipitation. The latter can be detected in various ways, such as, for example, by a sudden change in the conductivity of the precipitation medium or in the pH of the precipitation medium.

The additive can be introduced into the carbonation medium in the form of a solid, of a liquid, of a solution, of a suspension or of an emulsion.

When the calcium carbonate is precipitated by carbonation of a milk of lime, it is preferable to introduce the additive before the beginning of the introduction of the gas comprising the carbon dioxide into the milk of lime or to add it after the beginning of the introduction of the gas comprising the carbon dioxide into the milk of lime. The time elapsed between the beginning of the introduction of the gas comprising the carbon dioxide into the milk of lime and the beginning of the addition of the additive can be less than or equal to 40 minutes, preferably less than or equal to 20 minutes, very particularly preferably less than or equal to 10 minutes. A time of less than or equal to 5 minutes is particularly well suited. Preference is very especially given to the addition of the nonionic compound before the introduction of the gas comprising the carbon dioxide into the milk of lime.

According to a means which is particularly preferred in the context of the invention, calcium carbonate is precipitated by carbonation of a milk of lime with a gas comprising carbon dioxide. In this preferred means, the milk of lime is generally obtained by dispersion of fine particles of quick lime in water.

The calcium hydroxide content in the milk of lime is generally greater than or equal to 10 g (quick lime CaO)/l, preferably greater than or equal to 50 g/l and particularly preferably greater than or equal to 100 g/l. This content is usually less than or equal to 750 g/l, preferably less than or equal to 500 g/l and particularly preferably less than or equal to 250 g/l.

The gas comprising carbon dioxide can originate from a lime kiln intended to produce calcium oxide from limestone, from power station gases or from liquid CO₂ containers. The gas comprising carbon dioxide is advantageously a rich gas, particularly a lime kiln gas.

The carbon dioxide content of the gas is generally greater than or equal to 10% by volume, preferably greater than or equal to 20% by volume and very particularly preferably greater than or equal to 25% by volume. This content is usually less than or equal to 100% by volume, more specifically less than or equal to 60% by volume. A content of less than or equal to 40% by volume is particularly well suited.

The flow rate of the gas comprising the carbon dioxide is generally greater than or equal to 0.5 m³/h, preferably greater than or equal to 1 m³/h and very particularly preferably greater than or equal to 5 m³/h. This flow rate is usually less than or equal to 50 m³/h, more specifically less than or equal to 30 m³/h. A flow rate of less than or equal to 25 m³/h is particularly well suited.

That flow rate is usually depending on the size and type of equipments used to carry out the carbonation reaction.

The duration of the carbonation is generally greater than or equal to 0.1 s, preferably greater than or equal to 10 min and very particularly preferably greater than or equal to 25 min. This duration is usually less than or equal to 200 min, more specifically less than or equal to 170 min. A duration of less than or equal to 160 min is particularly well suited.

The carbonation temperature is generally greater than or equal to 2° C., preferably greater than or equal to 10° C. and very particularly preferably greater than or equal to 20° C. This temperature is usually less than or equal to 80° C., more specifically less than 65° C. A temperature of less than or equal to 40° C. is particularly well suited.

The suspensions according to the invention can thus be used as additives in papers, paints, coatings, inks, plastisols, polymers, pharmaceutical products, cosmetic products and foodstuffs.

The following examples serve to illustrate the invention without, however, limiting the scope of the claims.

### EXAMPLE 1

A stream of carbon dioxide gas comprising 30% by volume of CO₂ has been introduced into a 20 l reactor comprising a milk of lime with a concentration of quick lime (CaO) of 150 g/l and Synperonic®F 108 at a content of 2 g/l at a temperature of 20° C. and at a flow rate of 3.6 m³/h. After approximately 35 minutes, 100% of the calcium hydroxide has been converted into calcium carbonate.

The precipitated calcium carbonate has been filtered off and then dried at 50° C. for 5 h.

The size distribution of the aggregates of individual particles in the suspension has been determined by the sedimentation method (Micromeritics Sedigraph 5 100 and Horiba CAPA 700).

For the measurement with the Micromeritics Sedigraph 5 100 instrument, the preparation of the sample is as follows. The MasterTech 51 automatic preparator of Micromeritics has been used. 30 mL of deionized water containing 2 g/L of sodium hexamethaphosphate have been added to 20 mL of the calcium carbonate particles suspension. The resulting mixture has been mechanically stirred during 210 s and ultrasonically treated during 180 s (20 kHz, 50 W).

For the measurement with the Horiba CAPA 700 instrument, the calcium carbonate particles suspension has been used as such and the measurements have been made at a rotation speed of 960 rotations per minute.

The specific surface has been measured on the dried product using the BET method.

The size of the individual particles has been measured by the Léa-Nurse method.

### EXAMPLE 2

The conditions of Example 1 have been repeated, except that the Synperonic®F 108 content is 3.2 g/l.

### EXAMPLE 3

The conditions of Example 1 have been repeated, except that the Synperonic®F 108 content is 4 g/l.

### EXAMPLE 4

The conditions of Example 1 have been repeated, except that the compound Synperonic®F 108 has been added 3 minutes after the beginning of the introduction of the gas comprising the carbon dioxide.

### EXAMPLE 5

The conditions of Example 2 have been repeated, except that the compound Synperonic®F 108 has been added 3 minutes after the beginning of the introduction of the gas comprising the carbon dioxide.

### EXAMPLE 6

The conditions of Example 3 have been repeated, except that the compound Synperonic®F 108 has been added 3 minutes after the beginning of introduction of the gas comprising the carbon dioxide.

### EXAMPLE 7 COMPARATIVE EXAMPLE

The conditions of Example 1 have been repeated, except that no additive Synperonic®F 108 has been added.

The sizes of the individual particles (d_{P}) and of the aggregates (D₅₀) and the measurement of the width of the size distribution curve for the aggregates (SPAN) and the BET specific surface area at the end of the reaction are given in the following table.

| | Examples | | | | | | |
|---|---|---|---|---|---|---|---|
| | 1 | 2 | 3 | 4 | 5 | 6 | 7 |
| dₚ (nm) | 55 | 55 | 55 | 55 | 55 | 55 | 55 |
| D₅₀ (nm) | 1000 | 300 | 55 | 500 | 150 | 55 | 2750 |
| SPAN | 1.12 | 0.65 | 0.63 | 1.04 | 0.62 | 0.60 | 1.43 |
| S_{BET} | 25 | 25 | 25 | 25 | 25 | 25 | 25 |
| (m²/g) | | | | | | | |

1. An aqueous suspension of particles of precipitated calcium carbonate meeting the following requirements:
d_{P}≦D₅₀≦q.d_{P}
wherein d_{P} is the mean diameter of the particles (nm), as measured by the Léa-Nurse method, D₅₀ is the diameter of the particles (nm), for which 50% of the distribution (measured by the sedimentation technique) is smaller and 50% of the distribution is greater, and q is a number between 1.0 and 20.0, and
wherein said aqueous suspension further comprises at least one additive chosen from nonionic compounds comprising more than one carbon atom, the content of which, with respect to the calcium carbonate, is greater than 0.4% by weight.

2. The aqueous suspension according to claim 1, wherein the additive is chosen from condensates of alkylene oxide with an alcohol and polyalkylene glycols.

3. The aqueous suspension according to claim 2, wherein the additive is a triblock copolymer based on ethylene oxide and on propylene oxide or a compound of formula:
R—(OCH₂CH₂)ₚOH
wherein p is a number between 1 and 50, and R denotes an alkyl, aryl, alkylaryl or aralkyl group comprising a number of carbon atoms ranging from 1 to 30.

4. The aqueous suspension according to claim 1, wherein the content of additive, with respect to the calcium carbonate, is less than or equal to 4% by weight.

5. The aqueous suspension according to claim 1, wherein the calcium carbonate content in the suspension is less than or equal to 220 g/l and greater than or equal to 20 g/l.

6. The aqueous suspension according to claim 1, wherein the calcium carbonate particles exhibit a specific surface of greater than or equal to 10 m²/g and of less than or equal to 100 m²/g.

7. The aqueous suspension according to claim 1, wherein the calcium carbonate is calcite.

8. A process for the manufacture of a suspension according to claim 1, wherein the precipitated calcium carbonate is obtained by carbonation of milk of lime by a gas comprising carbon dioxide, in the presence of at least one additive chosen from nonionic compounds comprising more than one carbon atom, the content of which, with respect to the calcium carbonate, is greater than to 0.4% by weight.

9. The process according to claim 8, wherein the additive is added to the milk of lime before the introduction of the gas comprising carbon dioxide.

10. A method for preparing papers, paints, coatings, inks, plastisols, polymers, pharmaceutical products, cosmetic products and foodstuffs, said method comprising adding the suspension according to claim 1 as an additive to said papers, paints, coatings, inks, plastisols, polymers, pharmaceutical products, cosmetic products and foodstuffs.

11. A method for controlling the state of aggregation in the manufacture of suspensions of particles of precipitated calcium carbonate, said method comprising adding as an additive to the suspension of claim 1, a nonionic compound comprising more than one carbon atom.
